(19) United States
(12) Patent Application Publication
(10) Pub. No.: US 2010/0328358 A1
(43) Pub. Date: Dec. 30, 2010

(54) Driver circuit

(75) Inventor: Takeshi Mori, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/662,769

(22) Filed: May 3, 2010

(30) Foreign Application Priority Data
Jun. 26, 2009 (JP) 2009-152265

(51) Int. Cl. G09G 5/10; G09G 3/36

(52) U.S. Cl. 345/690; 345/87

(57) ABSTRACT

A driver circuit according to the present invention includes a grayscale circuit, an amplifier circuit, a comparison circuit, and a sampling timing adjusting circuit. The grayscale circuit generates a grayscale voltage from grayscale data. The amplifier circuit generates a video output from the grayscale voltage. The comparison circuit compares the grayscale voltage with the video output and outputs a comparison result. The sampling timing adjusting circuit adjusts a sampling timing signal for sampling the video signal based on the comparison result to generate an adjusted sampling timing signal.

### INCORPORATION BY REFERENCE

This application is based upon and claims the benefit of priority from Japanese patent application No. 2009-152265, filed on Jun. 26, 2009, the disclosure of which is incorporated herein in its entirety by reference.

### BACKGROUND

1. Field of the Invention

The present invention relates to a driver circuit, and particularly to a driver circuit for driving a liquid crystal display apparatus.

2. Description of Related Art

In a time-division type liquid crystal display apparatus, sampling of a video output signal is performed on a pixel to pixel basis because the video output signal changes pixel by pixel. Because the waveform of the video output signal which is the analog voltage is deformed by the load of the liquid crystal display apparatus, it is necessary to adjust the timing and to perform the sampling in the condition that the suitable voltage is output.

When the load is changed by the manufacturing variations, the changes of size or type of the liquid crystal display apparatus and the like, or when the operation speed is changed, it is necessary to suitably change the sampling timing.

In the related art, the sampling timing is decided by adjusting the timing suitably after checking the characteristics of the video output. FIG. 8 shows the configuration of a display driver circuit disclosed in Japanese Unexamined Patent Application Publication No. 2002-182605 (Senda et al.).

As shown in FIG. 8, a plurality of gate lines 110 are arranged at certain intervals in a horizontal direction and a plurality of data lines 120 are arranged at certain intervals in a vertical direction. A plurality of pixels arranged in matrix are separated by the plurality of gate lines 110 and the plurality of data lines 120.

TFTs 20 which are switching elements are arranged at each intersection of the gate lines 110 and the data lines 120. A gate of the TFT 20 is connected to the gate line 110, a drain of that is connected to the data line 120. A source of the TFT 20 is connected to a storage capacitor SC and a liquid crystal pixel 10. The other end of the storage capacitor SC is connected to Vsc. The other end of the liquid crystal pixel 10 is connected to Vcom.

A vertical driver 200 is connected to each gate line 110. The vertical driver 200 has shift registers 210 and buffers 220 corresponding to respective gate lines 110. The registers 210 are connected in series in a vertical direction. The registers 210 transfer a signal STV which is a pulse signal corresponding to a 1H (one horizontal scanning period) and indicating the start timing of a vertical scanning.

In this way, the gate lines 110 sequentially become HIGH level in the 1H. In addition, the buffers 220 enhance the current capability of the outputs of the shift registers 210 and the capability of charging/discharging drain lines (the data lines) which are capacitive loads. The gate lines 110 sequentially become HIGH level in the 1H so that the corresponding TFTs 20 turn ON.

A horizontal driver 300 is connected to each data line 120. The horizontal driver 300 has shift registers 310 arranged in a horizontal direction and switches 320 which are turned on and off by the shift registers 310 corresponding to respective data lines 120. The switches 320 are provided between a video signal line 330 and the data lines 120.

The shift registers 310 sequentially transfer a signal STH which indicates the start timing of a horizontal display signal using a signal CKH as a clock. The signal CKH indicates the timing of the video signal (the display data) transferred by the video signal line 330 for each of the dots (the pixels). The shift register 310 generates a sampling pulse in synchronization with the signal CKH and supplies it to the switch 320. The sampling pulse is a pulse signal which becomes HIGH level during two cycles of the signal CKH, for example.

The switch 320 is turned on in synchronization with the sampling pulse, which becomes HIGH level for each display data of the dot (the pixel), from the shift register 310. In this way, the display data transferred by the video signal line 330 is sequentially supplied to the data lines 120. In practice, one video signal may be divided into several video signals and these video signals may be supplied in parallel, or signals of RGB may be supplied in parallel. Then these signals may be written into the corresponding data lines at the same time.

As described above, each gate line 110 becomes HIGH level by the vertical driver 200 by 1H and the display data of each pixel is sequentially supplied to data lines 120. In this way, the display signal corresponding to the display data of each pixel is applied to the storage capacitor SC and the liquid crystal pixel 10 of each pixel to display an image.

As described above, the display data transferred by the video signal line 330 is sequentially supplied to the data line 120 through the switch 320 at the timing determined by the signal CKH. In view of this, it is necessary that the display data (the video signal) of the video signal line 330 is synchronized with the signal CKH which is the base of generating the sampling pulse.

The sampling pulse, however, is generated in the shift register 310, and is supplied to the switch 320. The delay is occurred in transferring the sampling pulse to the switch 320. In addition, the signal CKH from outside is not input into the shift register 310 directly. Although it is not shown in the figure, the signal CKH is supplied to the shift register 310 through a capacitive load, a plurality of inverters, level shifter or the like. Besides, a buffer may be provided between the output of the shift register 310 and the switch 320.

Therefore, the sampling pulse for driving the switch 320 is delayed from the signal CKH supplied from the outside with certain amount of time. This delay time in the panel is varied according to LCD panels. Further, the delay time in one LCD panel may be varied with time. As a result, the sampling pulse and the video signal supplied from outside may be out of synchronization. Thus, the delay value is adjusted by a delay selector 40 and the adjusted signal CKH is supplied to the shift register 310.

FIG. 9 shows the configuration of a delay detecting circuit 50 of Senda et al. FIG. 10 shows the waveform of the delay detection in the delay detecting circuit of FIG. 9. The delay detecting circuit 50 detects the delay and controls the delay value in the delay selector 40 based on the delay value detected.

The signal CKH and the signal STV are input into a reference pulse generating unit 52. The reference pulse generating unit 52 includes a flip-flop 52a, a flip-flop 52b, an inverter 52c, a NAND gate 52d, and a flip-flop 52e. The flip-flop 52a receives the signal STV. The flip-flop 52b receives the output of the flip-flop 52a. The inverter 52c inverts the output of the flip-flop 52b. The NAND gate 52d executes NAND operation between the output of the inverter 52c and the output of the flip-flop 52a. The flip-flop 52e holds the output of the NAND gate 52d. The signal CKH is input into clock input terminals of flip-flops 52a, 52b, 52e.

As shown in FIG. 10, the flip-flop 52a retrieves HIGH level at the rise of the signal CKH after the signal STV becomes HIGH level at the first time in one frame. The output of the flip-flop 52b is LOW level, so that the output of the NAND gate 52d becomes LOW. Then the flip-flop 52b retrieves HIGH level at the next rise of the signal CKH, so that the output of the NAND gate 52d becomes HIGH.

The reference pulse remains HIGH during the vertical flyback period. Thus, the output of the NAND gate 52d becomes LOW level only in the first one cycle of the signal CKH of one frame. The output of the NAND gate 52d is retrieved by the flip-flop 52e. Therefore, the reference pulse which is output from the flip-flop 52e becomes LOW level only in the one cycle of the signal CKH from when the output of the NAND gate 52d is HIGH level.

The reference pulse is input to a delay detecting unit 54. The delay detecting unit 54 has seven delay units 54a-54g that are connected in series. Further, the delay detecting unit 54 has three NOR gates 54h-54j that execute NOR operation between the outputs of the delay unita 54e-54g and the respective reference pulses.

The delay detecting unit 54 is made up of delay units 54a-54d and delay units 54e-54g. Delay units 54a-54d are made up of the same members on a route from an input end through which the signal CKH is input to the LDC panel to the switch 320 to simulate the delay value in driving the switch 320 by the signal CKH. Delay units 54e-54g adjust the delay value to be one cycle of the reference pulse.

The members on a route from an input end through which the signal CKH is input to the LCD panel to the switch 320 include a level shifter, a buffer of the level shifter, a shift register, a buffer of the shift register or the like. Delay units 54a-54d are made up of these same members. It is preferable to consider a load of the lines or the like. It is not limited to the above configuration. Another configuration can be used if the same delay as the delay of the signal CKH can be given. The delay of the signal CKH can be simulated using different delay circuits. In consideration of the manufacturing variations and temporal change of the elements that constitute the route of the signal CKH, it is preferable to simulate the delay using the circuit which has the same members as those of the actual circuit.

When the delay value of the delay detecting unit 54 is small, that is, when the delay value of the simulation circuit is small, the period in which both output of the delay unit 54e and reference pulse are LOW is occurred. On the other hand, when the delay value of the delay detecting unit 54 is large, that is, when the delay value of the simulation circuit is large, the period in which both output of the delay unit 54e and reference pulse are LOW is not occurred.

In the delay detecting unit 54, the delay value is detected by comparing a plurality of delay signals with the reference pulse. Thus, the delay value can be detected without a counter or the like. Consequently, it can be constituted with a small circuit scale.

Respective outputs of the three NOR gates 54h-54j of the delay detecting unit 54 are input to a latch circuit 56. The output of the NAND gate 52d of the reference pulse generating unit 52 is supplied to the latch circuit 56 through an inverter 53.

The latch circuit 56 has three latches 56a-56c, each consisting of two NOR gates. Signals from NOR gates 54h-54j are respectively supplied to latches 56a-56c as set signals. The signal from the inverter 53 is supplied to latches 56a-56c as a reset signal.

Each of the latches 56a-56c has two NOR gates 56-1 and 56-2. NOR gates 56-1 receives outputs of NOR gates 54h-54j of the delay detecting unit 54. NOR gates 56-2 receives output of the inverter 53. The output of the NOR gate 56-1 is input to the NOR gate 56-2, and the output of the NOR gate 56-2 is input to the NOR gate 56-1. Outputs of NOR gates 56-2 are outputs of latches 56a-56c.

In the latch circuit 56, HIGH level signal is supplied from the inverter 53 at the beginning of one frame (field) to reset all latches 56a-56c. Then, signals from NOR gates 54h-54j of the delay detecting unit 54 are input and stored in latches 56a-56c respectively.

When the delay value is small, three NOR gates 54h-54j output HIGH level. These signals are stored in three latches 56a-56c. When the delay value is large, three NOR gates 54h-54j does not output HIGH level. Three latches 56a-56c kees LOW level. Further, when the delay value is relatively small, two latches 56a and 56b store HIGH level. When the delay value is relatively large, only one latch 56a stores HIGH level.

As described above, the output of the latch circuit 56 is varied as “HHH”, “HHL”, “HLL”, “LLL” in order from smaller delay value depending on the amount of delay value. The output of the latch circuit 56 is input to a decoder 60. The decoder 60 outputs four signals on the basis of three input signals.

The output of the latch 56a is directly output as an output A. Further, the output of the 56a is input into NAND gates 60a, 60b and 60c. The output of the latch 56b is directly input into NAND gates 60b and 60c. The output of the latch 56b is inverted by the inverter 60d and input into the NAND gate 60a. The output of the latch 56c is directly input into the NAND gate 60c. The output of the latch 56c is inverted by the inverter 60e and input into the NAND gate 60b by the inverter 60e.

The output of the latch 56a is the output A. Outputs of NAND gates 60a, 60b and 60c are outputs B, C, and D respectively. Therefore, outputs A, B, C, and D become following signals respectively depending on three outputs of the latch circuit 56. Namely, “HHH” becomes “HHHL”, “HHL” becomes “HHLH”, “HLL” becomes “HLHH”, and “LLL” becomes “LHHH”.

In Senda et al., the delay value corresponding to the delay value of the video signal is generated in the delay detecting unit. The delay value is compared with the reference pulse from the reference pulse generating unit. The delay selector generates the delay which is equal to the delay of the video signal according to the comparison result. The delay is given to the clock for transmitting the video signal to the display apparatus. In this way, adjustment of the timing between the video signal and the clock for transmitting the video signal to the display apparatus can be performed.

### SUMMARY

The present inventor has found a following problem. That is, when the load is changed by the changes of size or type of the liquid crystal display apparatus and the like, the timing of the video signal is varied. Consequently, in Senda et al., adjustment of the sampling timing is not performed, and disturbance and the like in image display is occurred.

Further, because the delay detecting unit 54 is varied by the manufacturing variations, detecting result may differ among products. Because the delay selector 40 which gives the delay depending on the result of detected delay value is varied, the delay value may differ greatly due to products. Thus, it is difficult to adjust the sampling timing.

A first exemplary aspect of the present invention is a driver circuit including: a grayscale circuit generating a grayscale voltage from grayscale data; an amplifier circuit generating a video output from the grayscale voltage; a comparison circuit comparing the grayscale voltage with the video output and outputting a comparison result; a sampling timing adjusting circuit adjusting a sampling timing signal for sampling the video signal based on the comparison result to generate an adjusted sampling timing signal.

By adjusting the sampling timing by comparing the grayscale voltage and the video output voltage, the sampling can be performed in the condition that the suitable voltage is output even if the video signal is varied.

According to the present invention, there can be provided a driver circuit capable of performing the sampling in the condition that the suitable voltage is output even if the video signal is varied.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a diagram showing a configuration of a driver circuit according to a first exemplary embodiment of the present invention;

FIG. 2 is a timing chart to explain the method of adjusting the sampling timing in the driver circuit according to the first exemplary embodiment of the present invention;

FIG. 3 is a diagram showing a configuration of a driver circuit according to a second exemplary embodiment of the present invention;

FIG. 4 is a timing chart to explain the method of adjusting the sampling timing in the driver circuit according to the second exemplary embodiment of the present invention;

FIG. 5 is a diagram showing a configuration of a driver circuit according to a third exemplary embodiment of the present invention;

FIG. 6 is a timing chart to explain the method of adjusting the sampling timing in the driver circuit when the grayscale is changed according to the third exemplary embodiment of the present invention;

FIG. 7 is a timing chart to explain the method of adjusting the sampling timing in the driver circuit when the grayscale is not changed according to the third exemplary embodiment of the present invention;

FIG. 8 is a diagram showing a configuration of a display driver circuit of Senda et al.;

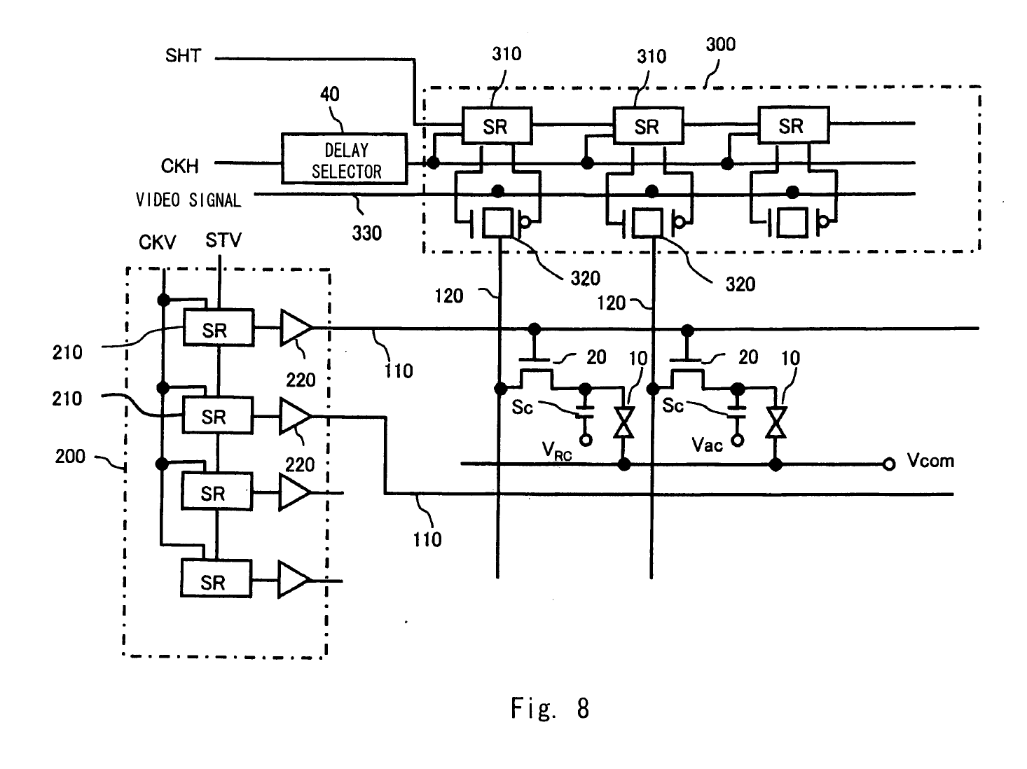

FIG. 9 is a diagram showing a configuration of a delay detecting circuit of Senda et al.; and

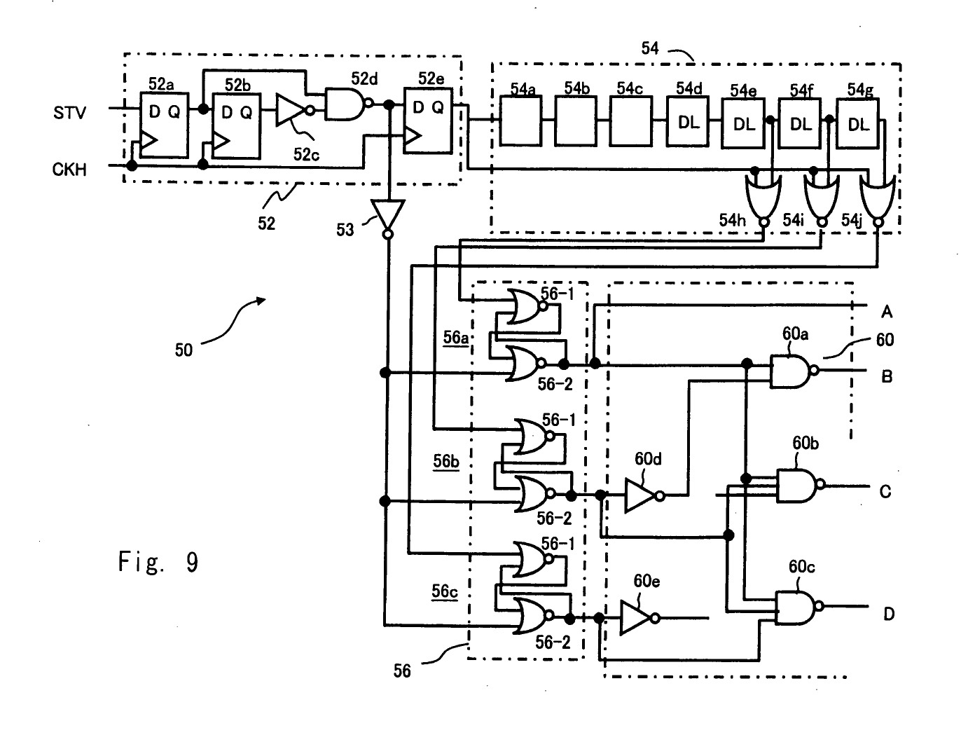

FIG. 10 is a waveform of delay detection in the delay detecting circuit of FIG. 9.

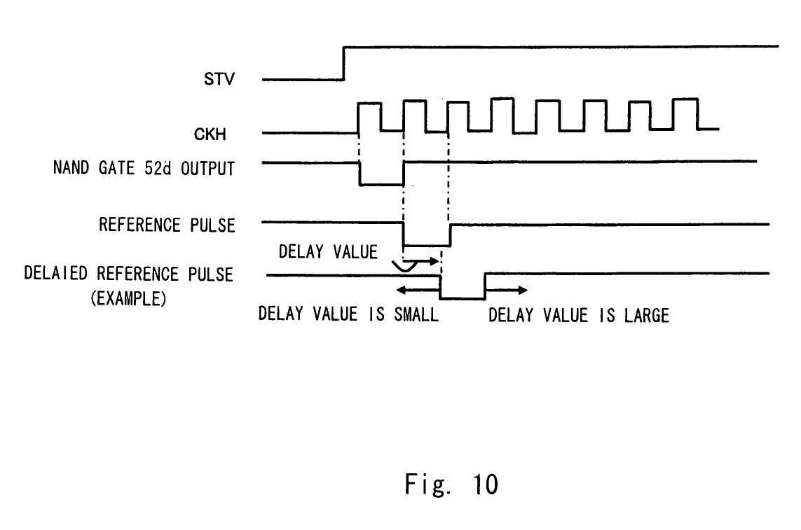

### DETAILED DESCRIPTION OF THE EXEMPLARY EMBODIMENTS

### First Exemplary Embodiment

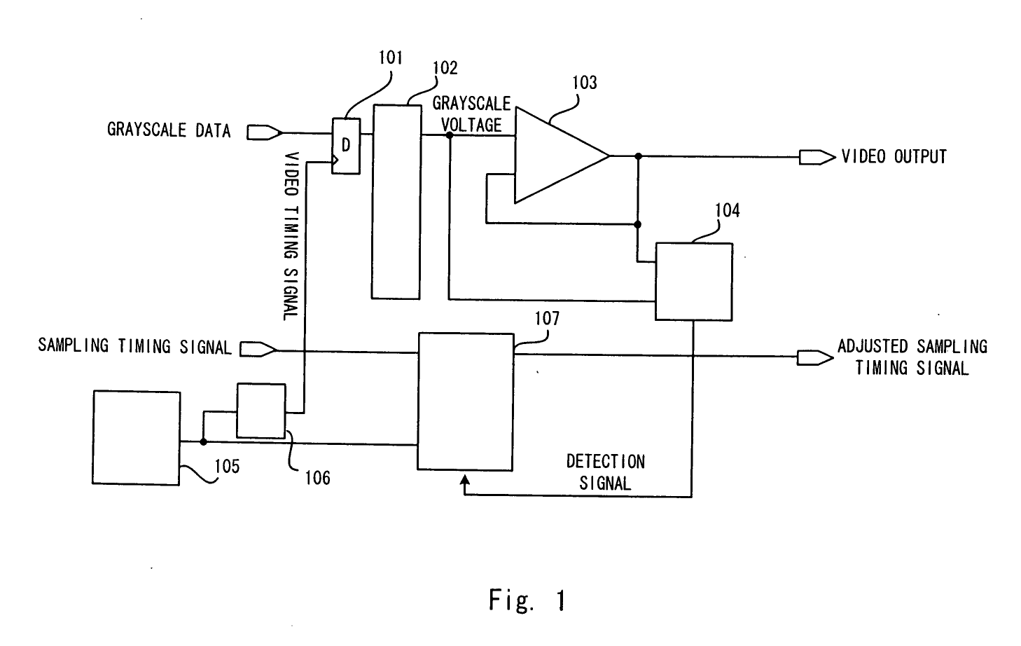

A driver circuit according to a first exemplary embodiment of the present invention will be described with reference to FIG. 1. FIG. 1 shows a configuration of the driver circuit according to the first exemplary embodiment. As shown in FIG. 1, the driver circuit according to the first exemplary embodiment includes a D flip-flop (D-F/F) 101, a grayscale circuit 102, an amplifier circuit 103, a comparison circuit 104, an oscillation circuit 105, a frequency division circuit 106, and a timing adjusting circuit 107.

The driver circuit according to the first exemplary embodiment is a source driver circuit for driving a liquid crystal display apparatus and has a function for adjusting the sampling timing.

The oscillation circuit 105 generates an oscillator output which is a clock signal and outputs it to the frequency division circuit 106. The frequency division circuit 106 generates a video timing signal based on the oscillator input from the oscillation circuit 105. The video timing signal is input into the D-F/F 101.

The D-F/F 101 synchronizes grayscale data with the video timing signal, and then inputs the grayscale data into the grayscale circuit 102. The grayscale circuit 102 generates a grayscale voltage according to the grayscale data. The grayscale voltage is amplified by the amplifier circuit 103 and output as a video output.

The grayscale voltage generated in the grayscale circuit 102 and the video signal are input into the comparison circuit 104. The comparison circuit 104 compares the grayscale voltage with the video signal and outputs a detection signal which is the result of the comparison. In this exemplary embodiment, the comparison circuit 104 outputs the detection signal when the video output reaches the grayscale voltage and the video output becomes substantially equal to the grayscale voltage.

The timing adjusting circuit 107 receives a sampling timing signal, the oscillator output from the oscillation circuit 105, and the detection signal from the comparison circuit 104. The timing adjusting circuit 107 adjusts the sampling timing signal based on these signals and generates an adjusted sampling timing signal. In this exemplary embodiment, the timing adjusting circuit 107 changes the timing of the falling of the adjusted sampling timing signal based on the result of comparing the grayscale voltage with the video output.

The adjusted sampling timing signal becomes HIGH level at the rising edge of the waveform of the output from the oscillation circuit 105 when the sampling timing signal is raised. The adjusted sampling timing signal becomes LOW level at the falling edge of the waveform of the output from the oscillation circuit 105 when the detection signal is raised.

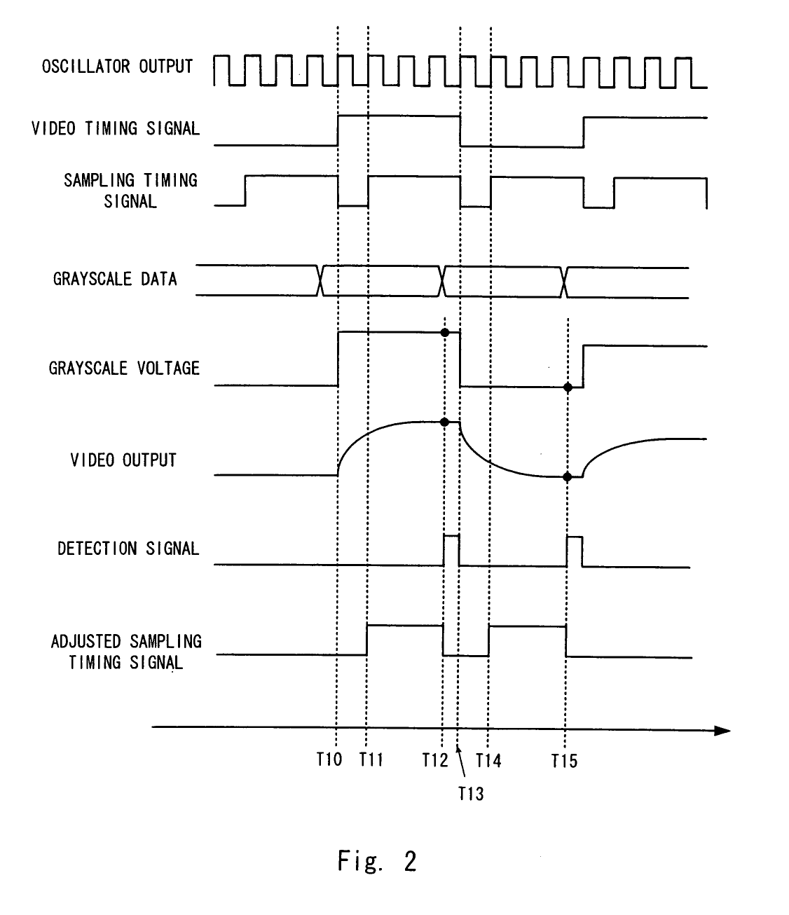

Referring to FIG. 2, a method of adjusting the sampling timing signal in the driver circuit according to this exemplary embodiment is described. FIG. 2 is a timing chart to explain the method of adjusting the sampling timing according to the first exemplary embodiment.

As shown in FIG. 2, at the timing T10, the grayscale voltage and the video output are changed at the same time by the grayscale data synchronized with the video timing signal obtained by frequency-dividing the output of the oscillation circuit 105. Because the waveform of the video output is deformed by the load of the liquid crystal display, the rising of the video output takes longer time than the grayscale voltage. At the timing T12, when the grayscale voltage and the video output have the same voltage, the detection signal is output from the comparison circuit 104.

The timing adjusting circuit 107 raises the adjusted sampling timing signal at the rising edge of the sampling timing signal at the timing T11. Further, the timing adjusting circuit 107 lowers the adjusted sampling timing signal at the rising edge of the detection signal at the timing T12. In a period between the timing T13 and T15, the adjusted sampling timing signal can be generated by executing the same operation as in the period between the timing T10 and T12.

According to this exemplary embodiment, the grayscale voltage is compared with the voltage of the video output to determine the sampling timing. Even when the waveform of the video output is deformed due to the variation of the load depending on the manufacturing of the liquid crystal display apparatus or the fluctuation of output characteristics by the source driver circuit, the ending timing of the sampling can be determined automatically when the video output reaches the grayscale voltage to generate the adjusted sampling timing signal.

Thus, the sampling can be performed in the condition that the suitable video voltage is output. Further, even if the type or the size of the liquid crystal display apparatus is changed, the sampling can be performed when the desired video output is obtained to suppress the defective display or the like

### Second Exemplary Embodiment

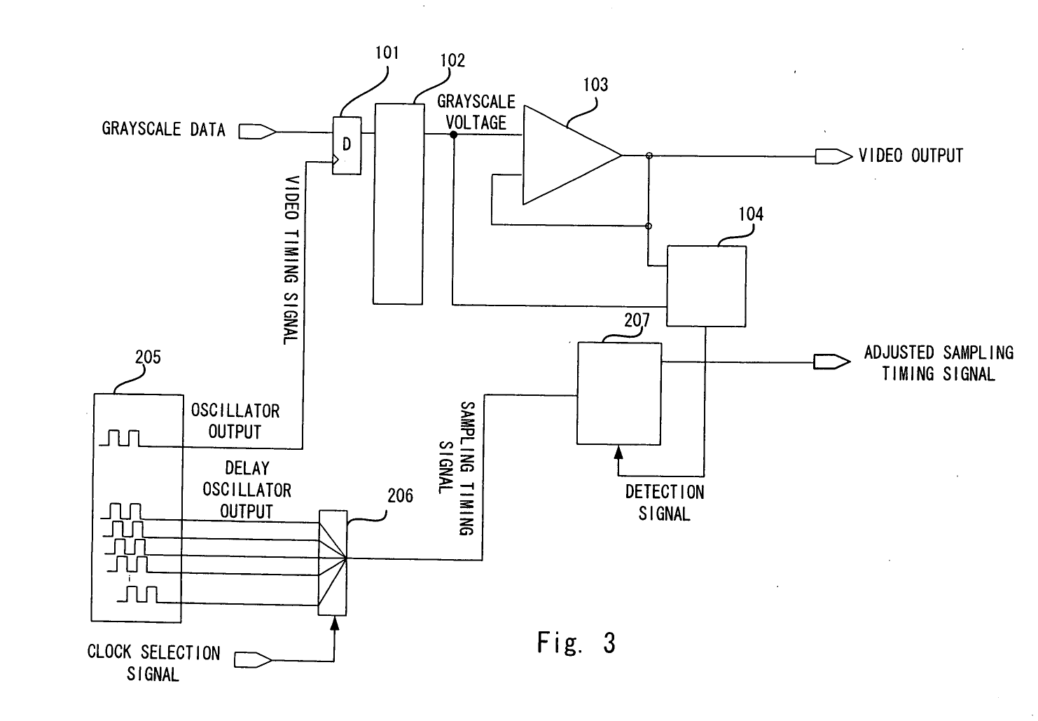

A driver circuit according to a second exemplary embodiment of the present invention will be described with reference to FIG. 3. FIG. 3 shows a configuration of the driver circuit according to the second exemplary embodiment. In FIG. 3, the same components as those in FIG. 1 are denoted by the same reference symbols, and the description thereof is omitted.

As shown in FIG. 3, in this exemplary embodiment, an oscillation circuit 205, a clock selecting circuit 206 and a timing adjusting circuit 207 are provided in place of the oscillation circuit 105, the frequency division circuit 106 and the timing adjusting circuit 107.

The oscillation circuit 205 outputs a plurality of oscillation frequencies, whose phases are different from each other, including an oscillator output and a plurality of delay oscillator outputs. The oscillator output among the plurality of oscillation frequencies is used as a video timing signal to perform the generation of the video output using the grayscale voltage.

The clock selecting circuit 206 selects one of the delay oscillator outputs having a phase-lag relative to the oscillator output based on the clock selection signal. One of the delay oscillator outputs selected by the clock selecting circuit 206 is used as the sampling timing signal.

The timing adjusting circuit 207 generates the adjusted sampling timing signal which rises at the rising edge of the sampling timing signal and falls at the rising edge of the detection signal. That is, the rising edge of the delay oscillator output having a phase-lag relative to the oscillator output is the rising timing of the adjusted sampling timing signal. Besides, as described in the first exemplary embodiment, the falling edge of the adjusted sampling timing signal is determined based on the result of comparing the grayscale voltage with the video output.

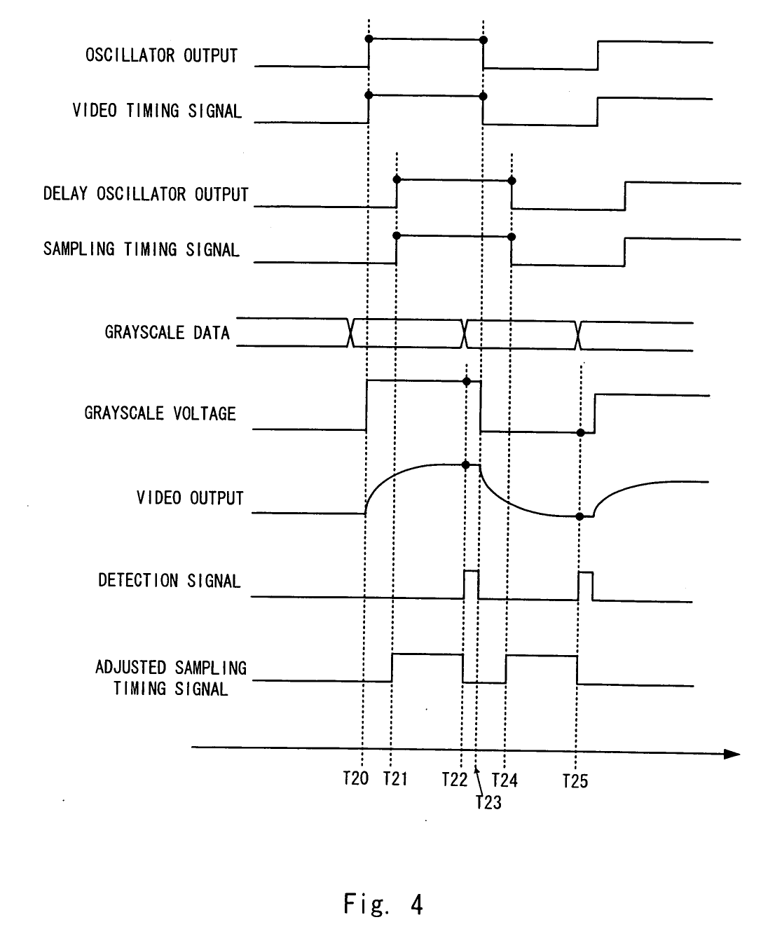

Referring to FIG. 4, a method of adjusting the sampling timing signal in the driver circuit according to this exemplary embodiment is described. FIG. 4 is a timing chart to explain the method of adjusting the sampling timing according to the second exemplary embodiment.

As shown in FIG. 4, in this exemplary embodiment, the oscillator output from the oscillation circuit 205 is used as the video timing signal. Thus, the oscillator output and the video timing signal have the similar waveforms. Further, the delay oscillator output selected by the clock selection signal is used as the sampling timing signal.

At the timing T20, the grayscale voltage and the video output are changed at the same time the video timing signal changes. As described above, because the waveform of the video output is deformed by the load of the liquid crystal display, the rising of the video output takes longer time than the grayscale voltage. At the timing T22, when the grayscale voltage and the video output have the same voltage, the detection signal is output from the comparison circuit 104.

The adjusted sampling timing signal rises at the rising edge of the sampling timing signal at the timing T21 and falls at the rising edge of the detection signal at the timing T22. In a period between the timing T23 and T25, the adjusted sampling timing signal can be generated by executing the same operation as in the period between the timing T20 and T22.

In this exemplary embodiment, the oscillator output of the oscillation circuit 205 is directly used as the video timing signal. Moreover, the delay oscillator output resulting from changing the phase of the oscillator output is used as the sampling timing signal. Therefore, the diver circuit can be operated at a high operating frequency without the frequency division to reduce the power consumption.

For example, if the frequency division circuit 106 has ⅛ frequency-dividing function in the first exemplary embodiment, the operating frequency of the oscillation circuit 205 may be reduced by ⅛ in the second exemplary embodiment compared with the oscillation circuit 105. In this case, the power consumption of the oscillation circuit 205 can be reduced by ⅛ compared with the oscillation circuit 105.

In the first exemplary embodiment, adjustment of the sampling timing is performed by counting the edge of the clock having high frequency which is output from the oscillation circuit 105. On the other hand, in this exemplary embodiment, the oscillation circuit 205 outputs a plurality of oscillation frequencies whose the phases are different from each other. Thus the frequencies of the oscillation circuit 205 can be lowered. Further, in this exemplary embodiment, the delay oscillator output is directly used as the sampling timing signal. Adjustment of the sampling timing can be performed without relying on the clock edge. Therefore, the circuit to count the clocks can be reduced, thereby simplifying the configuration of the timing adjusting circuit 207 in comparison with the first exemplary embodiment.

### Third Exemplary Embodiment

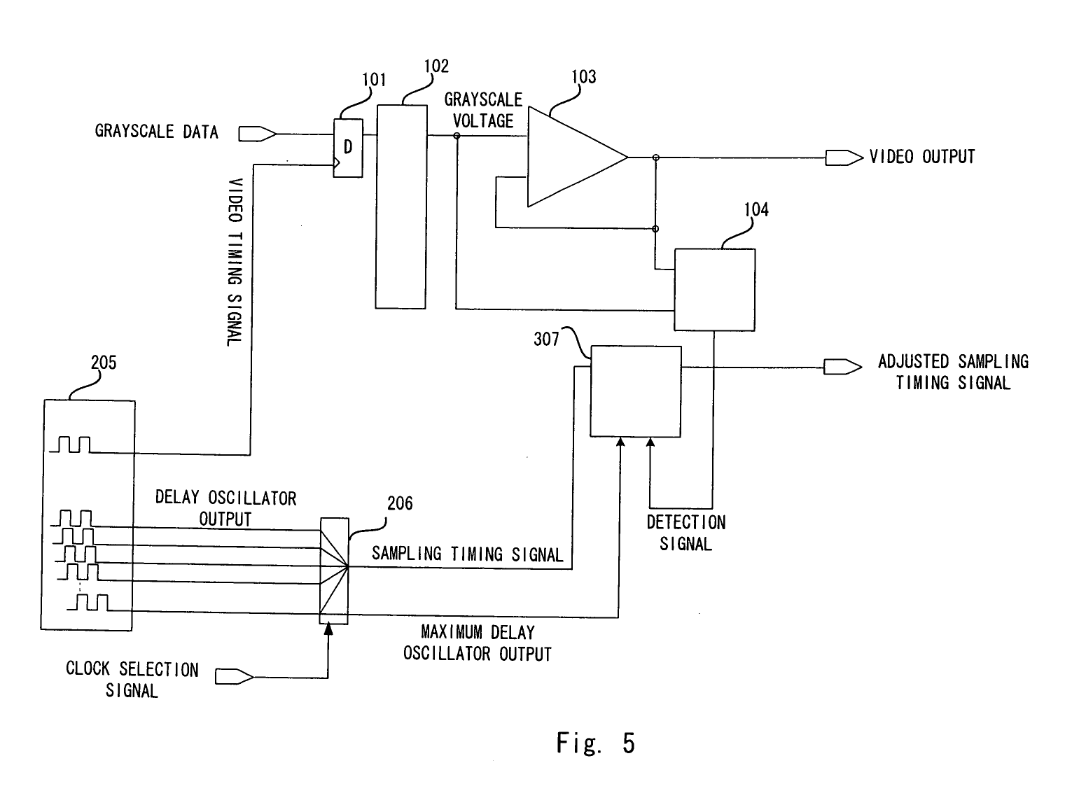

A driver circuit according to a third exemplary embodiment of the present invention will be described with reference to FIG. 5. FIG. 5 shows a configuration of the driver circuit according to the third exemplary embodiment. In FIG. 5, the driver circuit according to this exemplary embodiment has the oscillation circuit 205 having the same function as that in the second exemplary embodiment. In this driver circuit, the adjusted sampling timing signal is generated in a timing adjusting circuit 307 using the detection signal from the comparison circuit 104 and the delay oscillator output selected by the clock selection signal.

A delay oscillator output, which is one of the plurality of the delay oscillator outputs generated in the oscillation circuit 205, having a phase-lag relative to the delay oscillator output selected based on the clock selection signal is input into the timing adjusting circuit 307. In this exemplary embodiment, a maximum delay oscillator output having the largest delay is input into the timing adjusting circuit 307. The timing adjusting circuit 307 generates the adjusted sampling timing signal. The adjusted sampling timing signal rises at the rising edge of the sampling timing signal and falls at the timing of either the rising edge of the detection signal or the rising edge of the maximum delay oscillator output which is raised at the a\earlier timing.

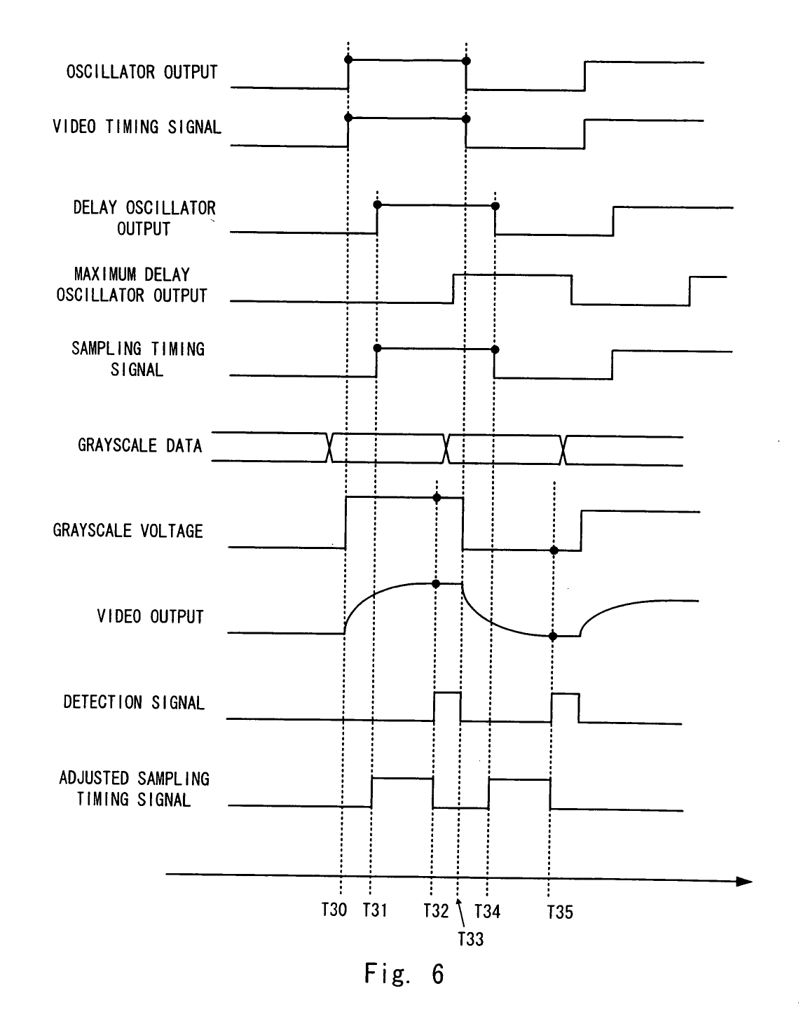

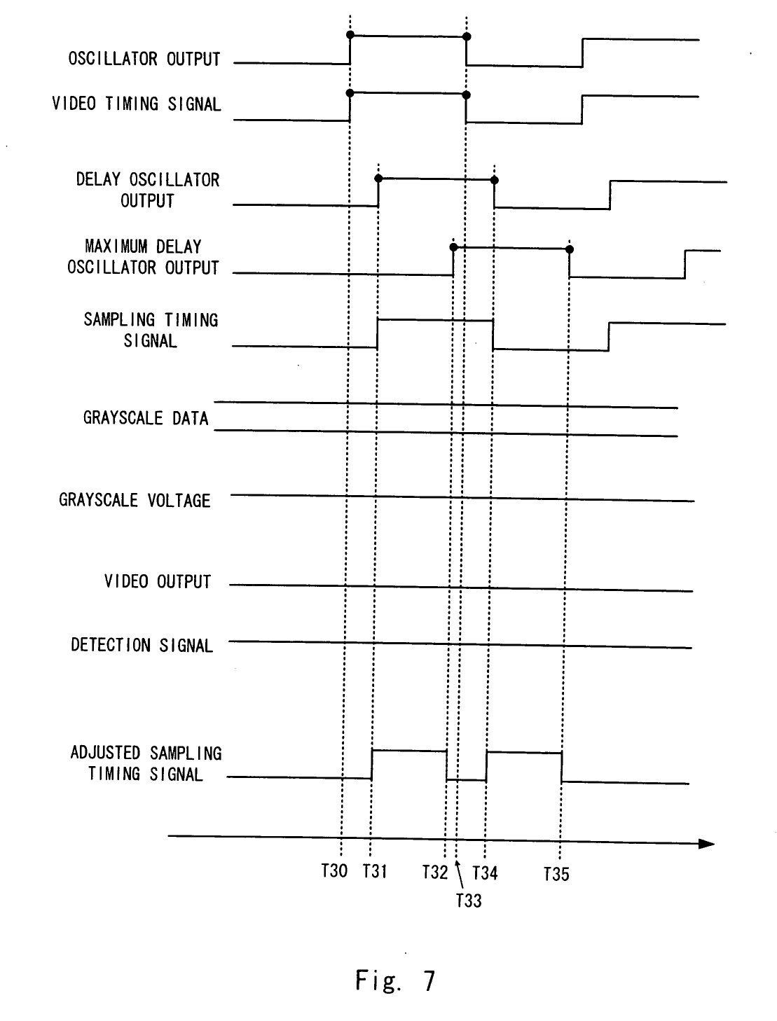

Referring to FIGS. 6 and 7, a method of adjusting the sampling timing signal in the driver circuit according to this exemplary embodiment is described. FIG. 6 is a timing chart to explain the method of adjusting the sampling timing in the driver circuit when the grayscale is changed. As shown in FIG. 6, if the grayscale is changed, the adjusted sampling timing signal is generated by the operation described in the second exemplary embodiment and the description thereof is omitted.

FIG. 7 is a timing chart to explain the method of adjusting the sampling timing in the driver circuit when the grayscale is not changed. As shown in FIG. 7, if the grayscale data is not changed, neither the grayscale voltage nor the video output is changed from a certain voltage. In this case, the detection signal which is the reference signal for determining the falling edge of the adjusted sampling timing signal is not output. Therefore, it is needed to provide another signal which functions as a reference for determining the falling edge of it.

In this exemplary embodiment, if the grayscale data is not changed, the maximum delay oscillator output, which is one of the plurality of the delay oscillator outputs generated in the oscillation circuit 205, having the largest delay functions as a reference for determining the falling edge of the adjusted sampling timing signal. Therefore, if the grayscale data is not changed, the adjusted sampling timing signal falls at the rising edge of the maximum delay oscillator output at the timing T32.

That is, the timing adjusting circuit 307 determines the falling of the adjusted sampling timing signal based on either the detection signal or the maximum delay oscillator output which is output at the earlier timing. According to this, sampling can be performed once for each generation of one pixel without depending on the video signal changes.

As described above, according to the present invention, by adjusting the sampling timing by comparing the voltages, the optimal adjusted sampling timing signal can be generated even if the video signal is varied by load or the like.

Further, by using the oscillation circuit which generates a plurality of oscillation frequencies whose phases are different from each other, the oscillation frequencies can be lowered without deteriorating the resolution of adjusting the timing to reduce the power consumption of the oscillation circuit. Besides, the circuit to count the clocks can be eliminated in the timing adjusting circuit, thereby simplifying the configuration.

Moreover, the falling timing of the adjusted sampling timing signal is determined using both the detection signal from the comparison circuit and the delay oscillator output in the timing adjusting circuit. Therefore, the suitable adjusted sampling timing signal can be generated even if the grayscale data is not changed.

The first to third exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A driver circuit comprising:
a grayscale circuit generating a grayscale voltage from grayscale data;
an amplifier circuit generating a video output from the grayscale voltage;
a comparison circuit comparing the grayscale voltage with the video output and outputting a comparison result;
a sampling timing adjusting circuit adjusting a sampling timing signal for sampling the video signal based on the comparison result to generate an adjusted sampling timing signal.

2. The driver circuit according to claim 1, wherein the comparison circuit outputs the comparison result when the grayscale voltage becomes substantially equal to the video signal.

3. The driver circuit according to claim 1, wherein the sampling timing adjusting circuit changes the falling timing of the adjusted sampling timing signal based on the comparison result.

4. The driver circuit according to claim 1, further comprising an oscillation circuit generating a plurality of outputs having phases different from each other, wherein
a first output which is one of the plurality of outputs is used as a video timing signal for generating the video output from the grayscale voltage, and
a rising timing of a second output having a phase-lag relative to the first output is rising timing of the adjusted sampling timing signal.

5. The driver circuit according to claim 1, further comprising an oscillation circuit generating a plurality of outputs having phases different from each other, wherein
a first output which is one of the plurality of outputs is used as a video timing signal for generating the video output from the grayscale voltage,
a rising timing of a second output having a phase-lag relative to the first output is rising timing of the adjusted sampling timing signal, and
either a rising timing of the comparison result or a rising timing of a third output having a phase-lag relative to the second output which is raised at an earlier timing is a falling timing of the adjusted sampling timing signal.
